(19) United States
(12) Patent Application Publication
(10) Pub. No.: US 2007/0145800 A1
(43) Pub. Date: Jun. 28, 2007

(54) Fitting for a vehicle seat

(75) Inventors: Peter Thiel, Remscheid (DE); Christoph Peters, Wermelskirchen (DE); Hans Pfeiffer, Lohnsfeld (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: KEIPER GmbH & Co. KG

(21) Appl. No.: 11/655,467

(22) Filed: Jan. 19, 2007

Related U.S. Application Data
(63) Continuation of application No. PCT/EP05/06087, filed on Jun. 7, 2005.

(30) Foreign Application Priority Data
Jul. 22, 2004 (DE) 10 2004 035 599.1

(51) Int. Cl. B60N 2/02

(52) U.S. Cl. 297/367

(57) ABSTRACT

In a fitting for a vehicle seat, in particular a detent fitting for a motor vehicle seat, having a first fitting part; a second fitting part that can be rotated and locked relative to the first fitting part; at least one locking element (17) the longitudinal direction of which is aligned in the radial direction, in which the locking element (17) is movable between guiding segments of the first fitting part with play in the transverse direction, and the radially outward side of the locking element cooperating with the second fitting part for the locking process; and an eccentric that, for the locking process, bears against the radially inward side of the locking element (17), for moving the locking element (17) radially outward, the locking element (17) is separated into at least two segments (19, 20) along at least one dividing line (18).

### CROSS-REFERENCE TO RELATED APPLICATION

The present application is a continuation of International Application PCT/EP2005/006087, which was filed Jun. 7, 2005. The entire disclosure of PCT/EP2005/006087 is incorporated herein by reference.

### BACKGROUND OF THE INVENTION

The present invention relates to a fitting for a vehicle seat, in particular a detent fitting for a motor vehicle seat, with the fitting including a first fitting part; a second fitting part that can be rotated and locked relative to the first fitting part; at least one locking element the longitudinal direction of which is oriented in the radial direction in which the locking element is movably guided with play in the transverse direction between guiding segments of the first fitting part, and which cooperates with its radially outward side together with the second fitting part to accomplish the locking process; and an eccentric which in order to perform the locking process bears against the radially inward side of the locking element to move the locking element radially outward.

A fitting of this kind is known from DE 102 53 054 A1. To permit the mobility of the two locking elements, a certain amount of play exists in the transverse direction thereof, and in the locked fitting this results in a play between the second fitting part and thus, for example, also the backrest. In order to ensure that, due to additional manufacturing tolerances, this play does not result in so much mobility of the backrest that noticeable angular changes and noises occur, very low manufacturing tolerances are desirable, but this increases the manufacturing costs.

### BRIEF SUMMARY OF SOME ASPECTS OF EXEMPLARY EMBODIMENTS

One aspect of the present invention is the provision of improvements to the type of fitting mentioned above. In accordance with one aspect of the present invention, a fitting for a vehicle seat, in particular a detent fitting for a motor vehicle seat, includes a first fitting part, a second fitting part that can be rotated relative to the first fitting part, at least one locking element for being moved outward in a radial direction so that a radially outward side of the locking element cooperates with the second fitting part to at least partially lock the second fitting part relative to the first fitting part, and an eccentric for bearing against a radially inward side of the locking element to force the locking element outward in the radial direction so that the radially outward side of the locking element cooperates with the second fitting part to at least partially lock the second fitting part relative to the first fitting part. In accordance with one aspect of the present invention, the locking element extends in a longitudinal direction that is oriented in the radial direction, the locking element is positioned between guiding segments of the first fitting part, the guiding segments are for guiding the locking element in the radial direction with play in a transverse direction, the transverse direction is crosswise with respect to the longitudinal direction, and the locking element is separated along at least one dividing line into at least two segments.

Because the locking element, of which preferably two are provided, is separated into at least two segments along at least one dividing line, the existing play can be reduced or totally eliminated by a small relative movement in the transverse direction. As a result, the play between the fitting parts and thus also the seat components attached to the second fitting part, preferably the backrest, is also reduced. The reduction in play serves to avoid the generation of noises. The free movement of the locking elements in the guides can be slightly greater than in the case of the known fitting, and this increases the functional reliability.

The segments of the locking element defined by the dividing line are preferably radially different in their arrangement in order not to hinder the overall movement of the locking element in the longitudinal direction due to the mobility in the transverse direction. The radially further outward segment of the locking element is a toothed segment carrying the side of the locking element intended to cooperate with the second fitting part, i.e., typically a toothing that is thus not subdivided. Since the locking element is retracted, for example, by means of a driving plate that engages on a lug on the locking element to pull the locking element radially inwards, the lug is arranged preferably also on the toothed segment so that the functional elements of the locking element required to perform the locking process are all located on the toothed segment.

A pressure segment, of which two may also be provided, is located radially further inwards and is designed to cooperate with the eccentric, for example by means of the—preferably two—pressure cams at which the eccentric bears against the locking element. Typically each pressure segment has at least one of the pressure cams, although the toothed segment may also have one of the pressure cams.

Instead of using a driving plate, the locking element may also be retracted, for example, by means of the eccentric and a hook, which is preferably mounted on the pressure segment.

The dividing line should run, at least sectionally, with a constant curvature, incorporating also a linear path, in order to permit the desired mobility in the transverse direction. To achieve clear force conditions, the dividing line runs preferably straight, at least sectionally, and this may occur either in a single section or also in two sections at an angle to each other. In the latter case, in order to create the free space required for movement, it may be necessary for one of the sections to be widened into a gap, whose width, projected in the transverse direction, is at least as large as the play that is to be reduced.

The inventive fitting may be used as an adjuster, for example as a height adjuster or an inclination adjuster, in all types of vehicle seats having adjustable assemblies, for example an inclination-adjustable backrest or a height-adjustable and/or inclination-adjustable seat part.

Other aspects and advantages of the present invention will become apparent from the following.

### BRIEF DESCRIPTION OF THE DRAWINGS

In the following, the invention is explained in more detail on with reference to four exemplary embodiments illustrated in the drawings, in which:

FIG. 1 is a view of the locking element of the first exemplary embodiment,

FIG. 2 is a view of the locking element of the second exemplary embodiment,

FIG. 3 is a view of the locking element of the third exemplary embodiment,

FIG. 4 is a section through the first exemplary embodiment,

FIG. 5 is a schematic view of a vehicle seat,

FIG. 6 is a view of the locking element of the third exemplary embodiment in the unlocked state, and

FIG. 7 is a section through the fourth exemplary embodiment in the locked state.

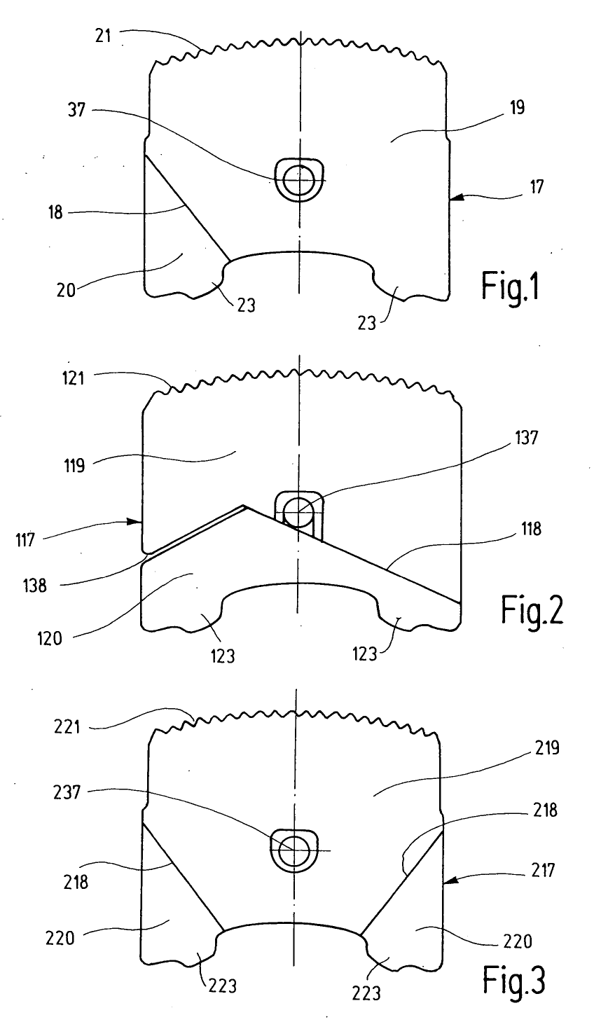

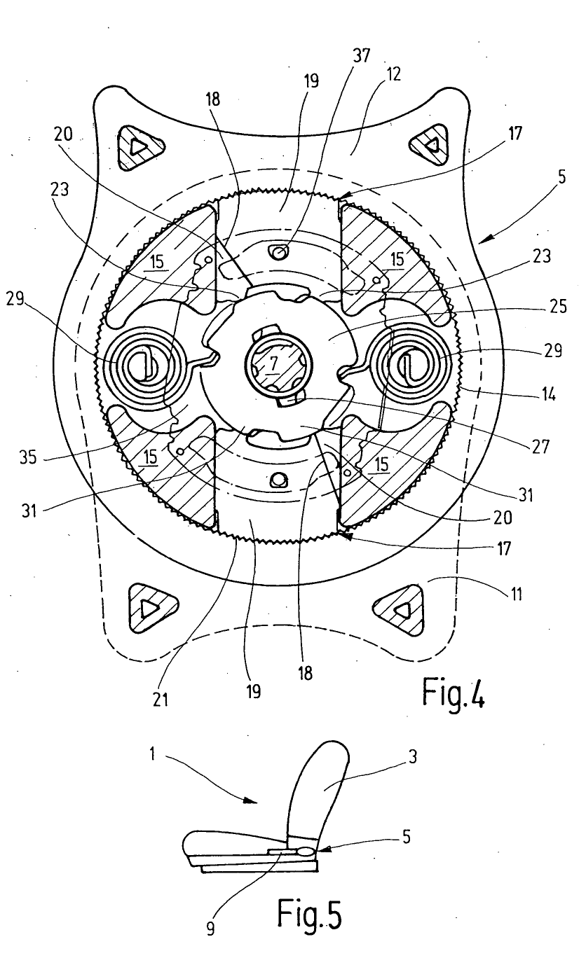

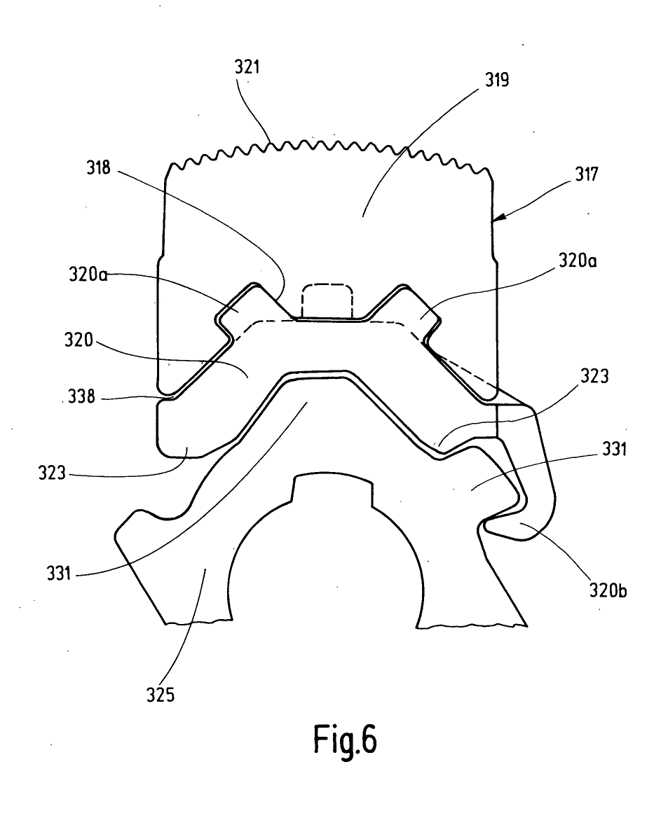

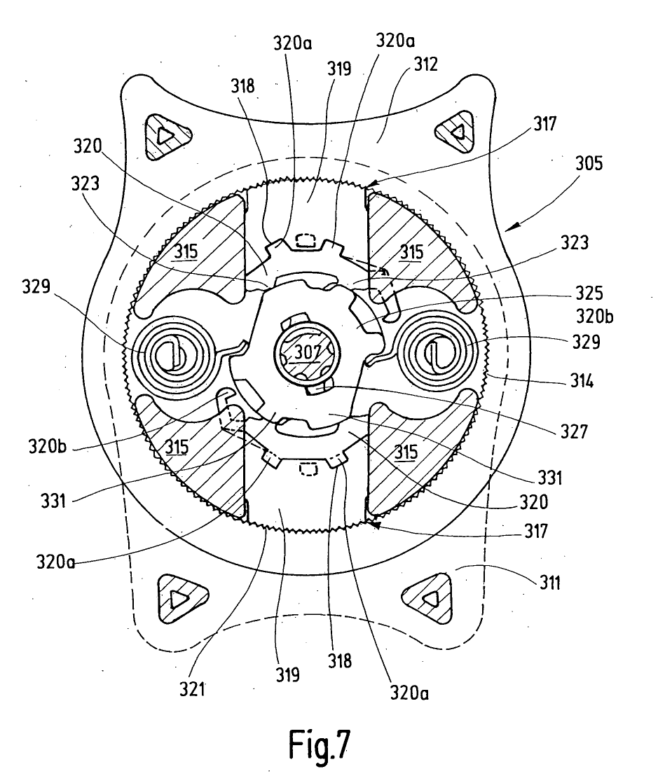

### DETAILED DESCRIPTION OF EXEMPLARY EMBODIMENTS

In the first three exemplary embodiments, a vehicle seat 1 of a motor vehicle has a fitting 5 on both sides of the seat for the adjustment of the backrest 3, the fitting is designed as a detent fitting, and, unless otherwise described below, it is the same as the fitting known from DE 102 53 054 A1. The entire disclosure of DE 102 53 054 A1 is explicitly incorporated herein by reference. The two fittings 5 are in geared connection with each other via a transmission rod 7. A hand lever 9, which is mounted in a rotationally fixed manner on the transmission rod 7, can be used to manually operate the fittings 5. The indications of direction given below with respect to the fitting 5 relate to the cylinder coordinate system defined by the transmission rod 7.

Each fitting 5 comprises a first fitting part 11 as a lower fitting part, and a second fitting part 12 as an upper fitting part. The first and second fitting parts 11, 12 are held together in the axial direction by retaining plates (not shown). The first fitting part 11, which is firmly attached to the seat part, is provided with four guiding and bearing segments 15. On their radially outward side, the four guiding and bearing segments 15 form a cylindrically shaped bearing surface, with four sections. This bearing surface of the first fitting part 11 is for a correspondingly curved, radially inward-facing bearing surface of the second fitting part 12. The second fitting part 12 is firmly attached to the backrest 3 and has the form of an internally geared wheel. This bearing surface of the second fitting part 12 is also provided with a toothing 14. In each case, two guiding and bearing segments 15 together form a guideway, which extends radially and is defined by parallel guiding surfaces, for a radially movable locking element 17. The direction of radial movement of the locking element 17 defines the locking element's longitudinal direction. The direction running perpendicular to the direction of movement of the locking element 17 and perpendicular to the axial direction of the fitting 5 is referred to in the following as the transverse direction. Altogether two locking elements 17 are provided and arranged point-symmetrically to the center of the fitting 5, i.e. to the transmission rod 7.

According to the invention, each of the altogether two locking elements 17 is separated along at least one dividing line 18, i.e. is formed in parts, with each locking element 17—with the exception of the division by the dividing line(s)—being formed with mirror-image symmetry relative to the longitudinal direction. In the first exemplary embodiment one single dividing line 18 is provided running in a straight line from one of the longitudinally oriented sides of the locking element 17, obliquely to the longitudinal direction and the transverse direction, through to the radially inner side of the locking element 17.

The dividing line 18 separates the locking element 17 into a toothed segment 19 that is arranged substantially further outward in the radial direction and extends as far as the radially outward side of the locking element 17, and into a pressure segment 20 arranged radially further inwards and bearing against the toothed segment 19 along the dividing line 18. On the convex curved, radially further outward side of the locking element 17, each toothed segment 19 carries a plurality of teeth 21 which can cooperate with the toothing 14 of the second fitting part 12 in order to lock the fitting 5. On the radially inward side of the locking element 17, the toothed segment 19 and the pressure segment 20 each carry a convex pressure cam 23, both pressure cams 23 being arranged apart from each other.

In order to force the two locking elements 19 radially outward (in the locking direction), a disc-shaped eccentric 25 is provided that is mounted by means of a bushing-shaped driving element 27 located on the transmission rod 7. While the driving element 27 is located in a rotationally rigid manner on the transmission rod 7, backlash is provided in the direction of rotation between the eccentric 25 and the driving element 27 to compensate for torsions in the transmission rod 7 and positional differences between the two fittings 5. The eccentric 25 is pretensioned in one direction of rotation, namely in the closing direction, by two spiral springs 29. At the outer circumference of the eccentric 25 four radially outward-projecting eccentric cams 31 are provided with one gripping face each, the latter being eccentrically curved in relation to the transmission rod 7. In the circumferential direction between the eccentric cams 31, the eccentric 25 is sufficiently recessed in a radially inward direction to accommodate the pressure cams 23.

A driving plate 35 is mounted in a rotationally fixed way on (e.g., for rotating with) the eccentric 25 and cooperates with the locking elements 17 in a known manner via slot-and-pin guides, for which purpose each toothed segment 19 possesses an axially projecting lug 37. The driving plate 35 serves to retract the locking elements 19 radially inwards, i.e. thereby to carry out the unlocking process, which is initiated by rotating the transmission rod 7 by means of the hand lever 9.

Starting from an unlocked state in which the two toothed segments 17 are located radially inwards, the eccentric 25 is rotated in such a manner by the pretensioning of the springs 29 that the eccentric cams 31 at first come to bear against the pressure cams 23 and then, in the course of further rotation, force the doubly supported locking elements 17 outward via the pressure cams 23. As soon as the toothed segments 19 engage the second fitting part 12, the respective fitting 5 is locked. An amount of play required in the transverse direction of the locking element 17 for the mobility of the locking elements 17 is now reduced as follows. The force of the eccentric 25 transmitted to the pressure cams 23, and acting in the longitudinal direction of the locking element 19, has a component along the dividing line 18 that causes the pressure segment 20 to move along the dividing line 18 on the side of the pressure segment 20, whereby due to the geometry of the dividing line 18 this movement possesses a component in the transverse direction of the locking element 19, by means of which the play is reduced or totally eliminated in the transverse direction.

The second exemplary embodiment is substantially similar to the first exemplary embodiment, unless otherwise described, and for that reason identical and identically acting components bear reference numbers raised by 100. The difference compared with the first exemplary embodiment relates to the division of the locking element 117. The dividing line 118 runs from one of the longitudinally oriented sides of the locking element 17, in the vicinity of a pressure cam 123, obliquely to the longitudinal and transverse directions, in a straight line to the center of the locking element 17, approaching the teeth 121, passing the lug 137 and then turning downwards at an obtuse angle to the other longitudinally oriented side of the locking element 117, so that the dividing line 118 widens to form a gap 138 and in this section moves away again in a straight line from the teeth 121. The path of the dividing line 118 again defines the toothed segment 119 and the pressure segment 120. When locking occurs, the dividing line 118, as in the first exemplary embodiment, ensures that the pressure segment 120 moves with a component in the transverse direction of the locking element 117, thereby reducing the play in the transverse direction. The gap 138 provided, the width of which is also reduced in the process, permits the pressure segment 120 to be mobile along the dividing line 118 in both directions. In a modified embodiment hereof, the dividing line 118 has three sections arranged in approximately step-shaped fashion relative to each other, and in this case the gap 138 is provided in the middle section running, for example, in the transverse direction.

The third exemplary embodiment is again substantially the same as the first exemplary embodiment and the second exemplary embodiment, unless otherwise described, and for that reason identical and identically acting components bear reference numbers raised by 200 and 100 respectively. The difference again relates to the division of the locking element 217. In addition to a dividing line 218 that corresponds to the dividing line 18, a further dividing line 218 is provided which is arranged with mirror symmetry with regard to the longitudinal direction of the locking element 217. Thus, per locking element 217 this defines one single toothed segment 219 which carries the teeth 221 and the lug 237, and two pressure segments 220, each of which carries a pressure cam 223.

The fourth exemplary embodiment is substantially the same as the other exemplary embodiments, unless otherwise described, and for that reason identical and identically acting components bear reference numbers raised by 300, 200 and 100 respectively. The fitting 305 of the fourth exemplary embodiment is also in geared connection with an identical fitting 305 on the other side of the vehicle seat by means of a transmission rod 307. The fitting 305 possesses a first fitting part 311 and a second fitting part 312 which is rotatably mounted by means of toothing 314 on four guiding and bearing segments 315 of the first fitting part 311. In each case a pair of guiding and bearing segments 315 form a guide for a locking element 317 which is radially movable in the longitudinal direction and is arranged with play in the transverse direction.

As in the other exemplary embodiments, a dividing line 318 separates the locking element 317 into a toothed segment 319 and a pressure segment 320 bearing against the toothed segment 319 along the dividing line 318. Sections of the dividing line 318 run in a straight line with the sections being arranged at angles of 45°, 90° and 135° to each other and running obliquely to the longitudinal direction of the locking element 317 or in the transverse direction. In order to ensure the relative mobility along the dividing line 318, various gaps 338 are provided as in the second exemplary embodiment. The functionally relevant sections of the dividing line 318 are formed on two inclined cams 320a integrally formed on the main part of the pressure segment 320 and projecting obliquely outward at an angle of 45°.

The toothed segment 319 carries radially outward a plurality of teeth 321 for cooperating with the toothing 314 of the second fitting part 312 in order to lock the fitting 305, while the pressure segment 320 carries radially inwards two pressure cams 323 spaced apart from each other. An eccentric 325, which is mounted—with a backlash—by means of a driving element 327 on the transmission rod 307, is pretensioned in the closing direction by two spiral springs 329 in order to act in each case with two of four eccentric cams 331 on the two pressure cams 323 of each locking element 317, forcing the locking element radially outward.

In contrast to the other exemplary embodiments, no driving plate is provided to retract the locking elements 317. Instead, a hook 320b is integrally formed on each pressure segment 320 and can engage behind one of the eccentric cams 331 when the eccentric 325 rotates with the transmission rod 307, so that the eccentric cam 331 pulls the pressure segment 320 and by means thereof—due to the arrangement of the inclined cams 320a—also the toothed segment 319 radially inwards and unlocks the fitting 305. The material thickness of the main part (i.e. without inclined cams 320a and hook 320b) of the pressure segment 320 is greater′than that of the toothed segment 319, whereas the inclined cams 320a have the same material thickness as the toothed segment 319 and are arranged in the plane thereof, while the hook 320b, which is formed with this difference in the material thicknesses, is arranged in a plane offset to the toothed segment 319.

It will be understood by those skilled in the art that while the present invention has been discussed above with reference to exemplary embodiments, various additions, modifications and changes can be made thereto without departing from the spirit and scope of the invention as set forth in the following claims.

What is claimed is:

1. A fitting for a vehicle seat, the fitting comprising:
a) a first fitting part;
b) a second fitting part that can be rotated relative to the first fitting part;
c) at least one locking element for being moved outward in a radial direction so that a radially outward side of the locking element cooperates with the second fitting part to at least partially lock the second fitting part relative to the first fitting part, wherein
(1) the locking element extends in a longitudinal direction that is oriented in the radial direction,
(2) the locking element is positioned between guiding segments of the first fitting part,
(3) the guiding segments are for guiding the locking element in the radial direction with play in a transverse direction,
(4) the transverse direction is crosswise with respect to the longitudinal direction, and
(5) the locking element is separated along at least one dividing line into at least two segments, and the at least one dividing line is configured so that there can be relative movement between the at least two segments of the locking element; and
d) an eccentric for bearing against a radially inward side of the locking element to force the locking element outward in the radial direction so that the radially outward side of the locking element cooperates with the second fitting part to at least partially lock the second fitting part relative to the first fitting part.

2. The fitting according to claim 1, wherein:
the at least two segments includes a toothed segment of the locking element, whereby the at least one dividing line at least partially defines the toothed segment, and
the toothed segment includes the radially outward side of the locking element that cooperates with the second fitting part to at least partially lock the second fitting part relative to the first fitting part.

3. The fitting according to claim 2, further comprising a driving plate that is for cooperating with a lug of the toothed segment to pull the locking element radially inward to at least partially unlock the fitting.

4. The fitting according to claim 1, wherein:
the at least two segments includes at least one pressure segment of the locking element, whereby the at least one dividing line at least partially defines the pressure segment; and
the eccentric bears against the pressure segment.

5. The fitting according to claim 4, wherein:
the locking element comprises two pressure cams;
the eccentric bears against the two pressure cams; and;
the pressure segment comprises at least one of the pressure cams.

6. The fitting according to claim 4, wherein:
the pressure segment is a first pressure segment;
the at least two segments includes a second pressure segment of the locking element, whereby the at least dividing line at least partially defines the second pressure segment; and
the eccentric bears against the second pressure segment.

7. The fitting according to claim 4, wherein the eccentric pulls the locking element radially inwards by way of a hook, which is on the pressure segment, to at least partially unlock the fitting.

8. The fitting according to claim 1, wherein at least a portion of the dividing line is straight.

9. The fitting according to claim 1, wherein at least a portion of the dividing line extends obliquely to the longitudinal and transverse directions.

10. The fitting according to claim 1, wherein the dividing line comprises at least two sections that are arranged so that an angle is defined between the two sections of the dividing line.

11. The fitting according to claim 10, wherein one of the sections of the dividing line at least partially defines a gap between at least two of the segments of the locking element.

12. The fitting according to claim 1 in combination with the vehicle seat, wherein the vehicle seat includes a backrest, and the fitting is configured for adjusting the backrest's inclination.

13. The fitting according to claim 2, wherein:
the at least two segments includes at least one pressure segment of the locking element, whereby the at least one dividing line at least partially defines the pressure segment; and
the eccentric bears against the pressure segment.

14. The fitting according to claim 5, wherein:
the pressure segment is a first pressure segment;
the at least two segments includes a second pressure segment of the locking element, whereby the at least one dividing line at least partially defines the second pressure segment; and
the second pressure segment comprises at least one of the pressure cams.

15. The fitting according to claim 2, wherein at least a portion of the dividing line is straight.

16. The fitting according to claim 4, wherein at least a portion of the dividing line is straight.

17. The fitting according to claim 8, wherein the straight portion of the dividing line extends obliquely to the longitudinal and transverse directions.

18. The fitting according to claim 8, wherein an angle is defined between:
the straight portion of the dividing line and another portion of the dividing line.

19. The fitting according to claim 1, wherein the at least one dividing line at least partially defines a gap between at least two of the segments of the locking element.

20. The fitting according to claim 1, wherein the relative movement, which can occur between at least two of the segments of the locking element, at least extends along the dividing line and in the transverse direction.
